(19) United States
(12) Patent Application Publication
(10) Pub. No.: US 2023/0262674 A1
(43) Pub. Date: Aug. 17, 2023

(54) RECEPTION INDICATING METHOD AND APPARATUS, AND RECEPTION CONTROL METHOD AND APPARATUS

(71) Applicant: Beijing Xiaomi Mobile Software Co., Ltd., Beijing (CN)

(72) Inventor: Yang LIU, Beijing (CN)

(21) Appl. No.: 18/005,138

(22) PCT Filed: Jul. 28, 2020
(86) PCT No.: PCT/CN2020/105166

§ 371 Date: Jan. 11, 2023

(51) Int. Cl. H04W 72/044

(52) U.S. Cl. CPC H04W 72/046; H04W 84/06

(57) ABSTRACT

The present application relates to a reception indicating method and apparatus, and a reception control method and apparatus. The reception indicating method comprises: determining an area corresponding to a wave beam to be turned off by a network device in the sky, and time information for turning off the wave beam; and sending the time information to a terminal in the area. According to the embodiments of the present application, by sending the time information to the terminal, the terminal can, according to the time information, determine at what time period the wave beam in the area is to be turned off, and then during the time period, stops receiving a downlink wave beam signal, stops sending an uplink wave beam signal, and stops detecting a wave beam signal, thereby avoiding unnecessary power consumption and saving energy of the terminal.

### CROSS-REFERENCE TO RELATED APPLICATION

This application is a national phase of International Application No. PCT/CN2020/105166, filed on Jul. 28, 2020, the entire content of which is incorporated herein by reference.

### TECHNICAL FIELD

The disclosure relates to the field of communications, and in particular, to a method for indicating a reception, a method for controlling a reception, an apparatus for indicating a reception, an apparatus for controlling a reception, an electronic device, and a computer-readable storage medium.

### BACKGROUND

In a non-terrestrial network (NTN), a base station and a terminal can communicate through a network device located in the air such as a satellite. Since the satellite is located in the air, a covered communication area can be increased. However, a manner that the satellite covers the communication area is different from a current manner that the base station covers the communication area.

### SUMMARY

According to a first aspect of the disclosure, a method for indicating a reception is provided, which is applicable to a base station. The method includes:
determining an area corresponding to beams that a network device located in the air will turn off and time information for turning off the beams; and
sending the time information to a terminal in the area.

According to a second aspect of the disclosure, a method for controlling a reception is provided, which is applicable to a terminal. The method includes:
receiving time information from a base station;
determining, based on the time information, a target duration during which a network device in the air will turn off beams: and
during the target duration, stopping receiving a downlink beam signal, stopping sending an uplink beam signal, and stopping detecting a beam signal.

According to a third aspect of embodiments of the disclosure, an electronic device is provided, including:
a processor; and
a memory for storing instructions executable by the processor;
the processor is configured to perform the method for indicating a reception as described in the first aspect and/or the method for controlling a reception as described in the second aspect.

According to a fourth aspect of embodiments of the disclosure, a computer-readable storage medium is provided, on which computer programs are stored, and when the programs are executed by a processor, the method for indicating a reception as described in the first aspect and/or the method for controlling a reception as described in the second aspect is performed.

### BRIEF DESCRIPTION OF THE DRAWINGS

The accompanying drawings used in the description of the embodiments are briefly introduced below. Obviously, the accompanying drawings in the following description are only used to illustrate example embodiments of the disclosure. For those skilled in the art, other embodiments can also be obtained.

FIG. 1 is a schematic flowchart of a method for indicating a reception according to some embodiments of the disclosure.

FIG. 2 is a schematic flowchart of a method for controlling a reception according to some embodiments of the disclosure.

FIG. 3 is a schematic flowchart of another method for controlling a reception according to some embodiments of the disclosure.

FIG. 4 is a schematic flowchart of yet another method for controlling a reception according to some embodiments of the disclosure.

FIG. 5 is a schematic flowchart of yet another method for controlling a reception according to some embodiments of the disclosure.

FIG. 6 is a schematic flowchart of yet another method for controlling a reception according to some embodiments of the disclosure.

FIG. 7 is a schematic block diagram of an apparatus for indicating a reception according to some embodiments of the disclosure.

FIG. 8 is a schematic block diagram of an apparatus for controlling a reception according to some embodiments of the disclosure.

FIG. 9 is a schematic block diagram of a device for indicating a reception according to some embodiments of the disclosure.

FIG. 10 is a schematic block diagram of a device for controlling a reception according to some embodiments of the disclosure.

### DETAILED DESCRIPTION

Technical solutions in embodiments of the disclosure will be clearly and completely described below with reference to the accompanying drawings in the embodiments of the disclosure. Obviously, the described embodiments are only a part of the embodiments of the disclosure, but not all of the embodiments. Based on the embodiments in the disclosure, all other embodiments obtained by those skilled in the art without creative efforts shall fall within the protection scope of the disclosure.

For the base station and the terminal in a conventional network, the base station is located on the ground and direct communication is possible between the base station and the terminal. The base station can send measurement beams to cover the communication area through periodic beam scanning or send service beams based on scheduling for a specific terminal. For measurement beams or service beams, the terminal knows information of the relevant beams, so that the terminal can determine the beams for measurement and the service beams for data transmission from the base station.

For the base station in the non-terrestrial network, the manner of covering the area is a beam hopping communication manner, that is, the base station can dynamically turn on or off beams in a certain area according to a distribution and services of terminals. If the terminal does not know whether beams in the area are turned off in time, the terminal continuously receives and detects beams in the area, and if the beams in the area have been turned off, it may result in the unnecessary power consumption of the terminal.

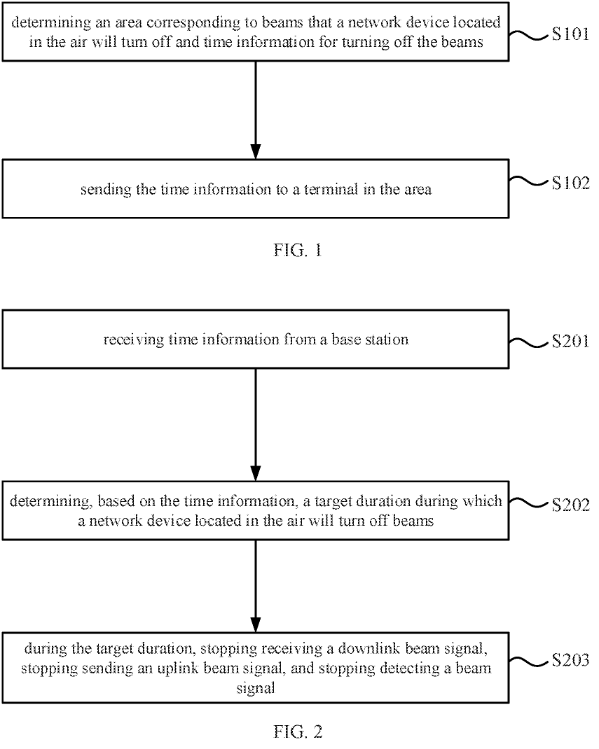

FIG. 1 is a schematic flowchart of a method for indicating a reception according to some embodiments of the disclosure. The method in some embodiments may be applicable to a base station. The base station may be a base station in a non-terrestrial network. For example, the base station may be a base station located on the ground or a network device located in the air. The network device located in the air may be a satellite or an aerial platform. The base station can communicate with a terminal. The terminal includes but is not limited to an electronic device such as a mobile phone, a tablet computer, a wearable device, a sensor, an Internet of Things device, or the like. The base station may be a fifth generation (5G) base station or a sixth generation (6G) base station.

As illustrated in FIG. 1, the method for indicating a reception may include the following steps.

In step S101, an area corresponding to beams that a network device located in the air will turn off and time information for turning off the beams are determined.

In step S102, the time information is sent to a terminal in the area.

In some embodiments, for the network device located in the air, it can cover a communication area where terminals are located by means of beam hopping communication, and the network device can dynamically turn on or off beams in a certain area based on a distribution and services of terminals in the communication area.

For the base station, the base station can determine the area corresponding to the beams that the network device located in the air will turn off and the time information for turning off the beams, while for the terminal located in the area, during the duration of turning off the beams in the area, if it is still continuously receiving and detecting beams in this area, it will result in the unnecessary power consumption of the terminal.

In some embodiments, the time information may be sent to the terminal through a specific signaling, so that after receiving the specific signaling, the terminal can determine that the role of the time information in the specific signaling is to stop receiving downlink beam signal, stop sending the uplink beam signal, and stop detecting the beam signal, during the target duration determined by the target information.

In some embodiments, the time information may also be carried in a specific field of a non-specific signaling and sent to the terminal, so that after receiving the non-specific signaling, when the specific field in the non-specific signaling contains the time information, the terminal can determine that the role of the time information is to stop receiving downlink beam signal, stop sending the uplink beam signal, and stop detecting the beam signal, during the target duration determined by the target information.

In addition, in the process of sending the time information to the terminal in the area, only the time information may be sent to implicitly indicate the terminal in the area. When the time information is received, it is determined that the time information is used to indicate the terminal that receives the time information.

In the process of sending the time information to the terminal in the area, the time information and area information of the area may be sent both, so that the terminal receiving the time information and the area information can determine whether the terminal is in the area based on the area information and further determine that the time information indicates the terminal in the case of being in the area.

In some embodiments, the time information is carried in at least one of the following signalings:

an extended paging channel signaling, a radio resource control (RRC) signaling, or physical layer downlink control information (DCI).

According to embodiments of the disclosure, by sending the time information to the terminal, the terminal can determine, based on the time information, which duration where the beams in the area are turned off, and then during this duration stop receiving the downlink beam signal, stop sending the uplink beam signal, and stop detecting the beam signal, to avoid the unnecessary power consumption and save the energy of the terminal.

It should be noted that, out of the duration, the terminal can normally receive the downlink beam signal, normally send the uplink beam signal, and normally detect the beam signal. For the terminal in this case, it can be called the terminal wake-up.

In some embodiments, the base station includes a base station located on the ground or the network device located in the air in the non-terrestrial network. When the base station is the base station located on the ground, the base station may forward the time information to the terminal through the network device located in the air.

Optionally, the time information includes a first start moment and a first duration.

In some embodiments, the time information sent by the base station to the terminal may include the first start moment and the first duration. In this case, the terminal may determine the start point of the target duration based on the first start moment, and the end point of the target duration based on the first start moment and the first duration, so as to determine the target duration based on the start point and the end point, and then stop receiving the downlink beam signal, stop sending the uplink beam signal, and stop detecting the beam, during the target duration.

Optionally, the time information includes an offset duration relative to a start point of a preset periodic time window and a second duration.

In some embodiments, the base station may preset the periodic time window, and then indicate relevant information of the time window to the terminal, so that when sending the time information, the base station may send the offset duration relative to the start point of the preset periodic time window and the second duration.

The terminal can determine a start point of the periodic time window based on the relevant information of the time window received in advance, and then determine the start point of the target duration based on the start point of the preset periodic time window and the offset duration, and determine the end point of the target duration based on the start point of the target duration and the second duration, so as to determine the target duration based on the start point and the end point, and then stop receiving the downlink beam signal, stop sending the uplink beam signal, and stop detecting the beam, during the target duration.

Optionally, the time information includes a second start moment.

In some embodiments, the base station may only send one start moment to the terminal, which is called the second start moment for convenience of description, and the terminal may store a duration in advance. The duration pre-stored by the terminal may be pre-indicated by the base station for the terminal or may be determined by the terminal based on the communication protocol with the base station.

Thus, the terminal can determine the start point of the target duration based on the second start moment and the end point of the target duration based on the second start moment and the pre-stored duration, so as to determine the target duration based on the start point and the end point, and then stop receiving the downlink beam signal, stop sending the uplink beam signal, and stop detecting the beam, during the target duration.

FIG. 2 is a schematic flowchart of a method for controlling a reception according to some embodiments of the disclosure. The method in some embodiments may be applicable to a terminal. The terminal may be in a non-terrestrial network. In the non-terrestrial network, the terminal may communicate with a base station, and the base station may be the base station applicable to the method for receiving an indication in any of the foregoing embodiments. The base station may also be other base stations, which is not limited in some embodiments.

The base station may be a base station located on the ground or a network device located in the air. The network device may be a satellite or an aerial platform. The terminal includes but is not limited to an electronic device such as a mobile phone, a tablet computer, a wearable device, a sensor, an Internet of Things device, or the like. The base station may be a 5G base station or a 6G base station.

As illustrated in FIG. 2, the method for controlling a reception may include the following steps.

In step S201, time information from a base station is received.

In step S202, a target duration during which a network device located in the air will turn off beams is determined according to the time information.

In step S203, during the target duration, it stops receiving a downlink beam signal, stops sending an uplink beam signal, and stops detecting a beam signal.

In some embodiments, for the network device located in the air, it can cover a communication area where terminals are located by means of beam hopping communication, and the network device can dynamically turn on or off beams in a certain area based on a distribution and services of the terminals in the communication area.

For the base station, the base station can determine the area corresponding to the beams that the network device located in the air will turn off and the time information for turning off the beams, while for the terminal located in the area, during the duration of turning off the beams in the area, if it is still continuously receiving and detecting beams in this area, it will result in the unnecessary power consumption of the terminal

According to embodiments of the disclosure, by sending the time information to the terminal, the terminal can determine, based on the time information, which duration where the beams in the area are turned off, and then during this duration stop receiving the downlink beam signal, stop sending the uplink beam signal, and stop detecting the beam signal, to avoid the unnecessary power consumption and save the energy of the terminal.

In some embodiments, the base station includes a base station located on the ground or the network device located in the air in the non-terrestrial network. When the base station is the base station located on the ground, the terminal can directly receive the time information from the base station, and when the base station is the network device located in the air, the terminal can receive the time information from the network device that the base station sends to the network device.

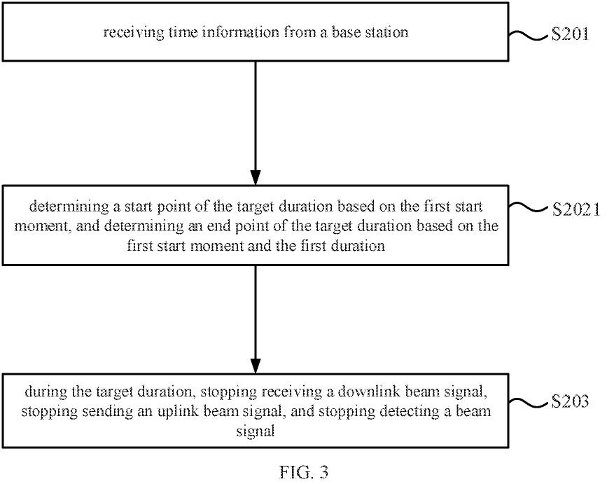

FIG. 3 is a schematic flowchart of another method for controlling a reception according to some embodiments of the disclosure. As illustrated in FIG. 3, the time information includes a first start moment and a first duration. Determining, based on the time information, the target duration during which the network device located in the air will turn off the beams includes the following.

In step S2021, a start point of the target duration is determined based on the first start moment, and an end point of the target duration is determined based on the first start moment and the first duration.

In some embodiments, the time information sent by the base station to the terminal may include the first start moment and the first duration. In this case, the terminal may determine the start point of the target duration based on the first start moment, and the end point of the target duration based on the start moment and the first duration, so as to determine the target duration based on the start point and the end point, and then stop receiving the downlink beam signal, stop sending the uplink beam signal, and stop detecting the beam, during the target duration.

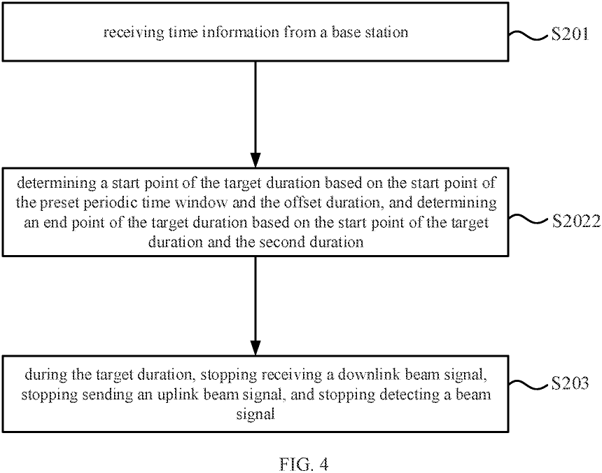

FIG. 4 is a schematic flowchart of yet another method for controlling a reception according to some embodiments of the disclosure. As illustrated in FIG. 4, the time information includes an offset duration relative to a start point of a preset periodic time window and a second duration. Determining, based on the time information, the target duration during which the network device located in the air will turn off the beams includes the following.

In step S2022, a start point of the target duration is determined based on the start point of the preset periodic time window and the offset duration, and an end point of the target duration is determined based on the start point of the target duration and the second duration.

In some embodiments, the base station may preset the periodic time window, and then indicate relevant information of the time window to the terminal, so that when sending the time information, the base station may send the offset duration relative to the start point of the preset periodic time window and the second duration.

The terminal can determine a start point of the periodic time window based on the relevant information of the time window received in advance, and then determine the start point of the target duration based on the start point of the preset periodic time window and the offset duration, and determine the end point of the target duration based on the start point of the target duration and the second duration, so as to determine the target duration based on the start point and the end point, and then stop receiving the downlink beam signal, stop sending the uplink beam signal, and stop detecting the beam, during the target duration.

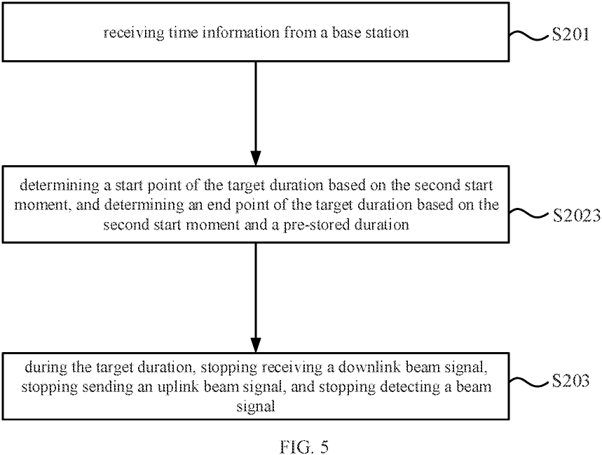

FIG. 5 is a schematic flowchart of yet another method for controlling a reception according to some embodiments of the disclosure. As illustrated in FIG. 5, the time information includes a second start moment. Determining, based on the time information, the target duration during which the network device located in the air will turn off the beams includes the following.

In step S2023, a start point of the target duration is determined based on the second start moment, and an end point of the target duration is determined based on the second start moment and a pre-stored duration.

In some embodiments, the base station may only send one start moment to the terminal, which is called the second start moment for convenience of description, and the terminal may store a duration in advance. The duration pre-stored by the terminal may be pre-indicated by the base station for the terminal or may be determined by the terminal based on the communication protocol with the base station.

Thus, the terminal can determine the start point of the target duration based on the second start moment and the end point of the target duration based on the second start moment and the pre-stored duration, so as to determine the target duration based on the start point and the end point, and then stop receiving the downlink beam signal, stop sending the uplink beam signal, and stop detecting the beam, during the target duration.

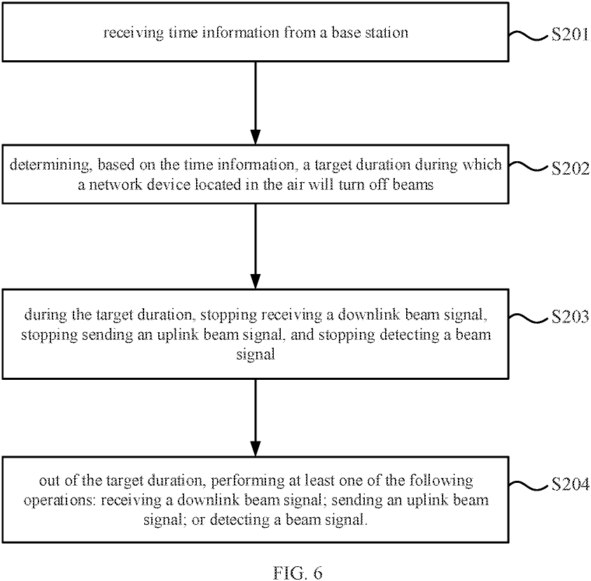

FIG. 6 is a schematic flowchart of still another method for controlling a reception according to some embodiments of the disclosure. As illustrated in FIG. 6, the method further includes the following.

In step S204, out of the target duration, at least one of the following operations is performed:
receiving a downlink beam signal;
sending an uplink beam signal; or
detecting a beam signal.

In some embodiments out of the target duration, the beam signal is normally turned on, and the terminal can normally perform one or more operations of: receiving the downlink beam signal, sending the uplink beam signal, or detecting the beam signal, thereby recovering the communication with the base station. For the terminal in this case, it can be called the terminal wake-up.

Corresponding to the foregoing embodiments of the method for indicating a reception and the method for controlling a reception, the disclosure also provides embodiments of an apparatus for indicating a reception and an apparatus for controlling a reception.

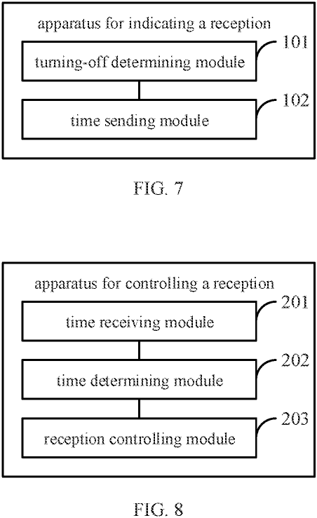

FIG. 7 is a schematic block diagram of an apparatus for indicating a reception according to some embodiments of the disclosure. The apparatus in some embodiments may be applicable to a base station. The base station may be a base station in a non-terrestrial network. For example, the base station may be a base station located on the ground or a network device located in the air. The network device located in the air may be a satellite or an aerial platform. The base station can communicate with a terminal. The terminal includes but is not limited to an electronic device such as a mobile phone, a tablet computer, a wearable device, a sensor, an Internet of Things device, or the like. The base station may be a 5G base station or a 6G base station.

As illustrated in FIG. 7, apparatus for indicating a reception may include: a turning-off determining module 101 and a time sending module 102.

The tuming-off determining module 101 is configured to determine an area corresponding to beams that a network device located in the air will turn off and time information for turning off the beams

The time sending module 102 is configured to send the time information to a terminal in the area.

Optionally, the time information includes a first start moment and a first duration.

Optionally, the time information includes an offset duration relative to a start point of a preset periodic time window and a second duration.

Optionally, the time information includes a second start moment.

Optionally, the time information is carried in at least one of the following signaling:

an extended paging channel signaling, an RRC signaling, or physical layer DCI.

Optionally, the base station includes a base station located on the ground or the network device located in the air in the non-terrestrial network.

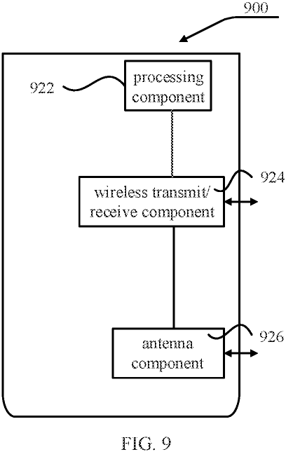

FIG. 8 is a schematic block diagram of an apparatus for controlling a reception according to some embodiments of the disclosure. The apparatus in some embodiments may be applicable to a terminal. The terminal may be in a non-terrestrial network. In the non-terrestrial network, the terminal may communicate with a base station, and the base station may be the base station applicable to the method for receiving an indication in any of the foregoing embodiments. The base station may also be other base stations, which is not limited in some embodiments.

The base station may be a base station located on the ground or a network device located in the air. The network device may be a satellite or an aerial platform. The terminal includes but is not limited to an electronic device such as a mobile phone, a tablet computer, a wearable device, a sensor, an Internet of Things device, or the like. The base station may be a 5G base station or a 6G base station.

As illustrated in FIG. 8, the apparatus for controlling a reception may include a time receiving module 201, a time determining module 202, and a reception controlling module 203.

The time receiving module 201 is configured to receive time information from a base station.

The time determining module 202 is configured to determine, based on the time information, a target duration during which a network device located in the air will turn off beams.

The reception controlling module 203 is configured to, during the target duration, stop receiving a downlink beam signal, stop sending an uplink beam signal, and stop detecting a beam signal.

Optionally, the time information includes a first start moment and a first duration, and the time determining module is configured to determine a start point of the target duration based on the first start moment, and determine an end point of the target duration based on the first start moment and the first duration.

Optionally, the time information includes an offset duration relative to a start point of a preset periodic time window and a second duration, and the time determining module is configured to determine a start point of the target duration based on the start point of the preset periodic time window and the offset duration, and determine an end point of the target duration based on the start point of the target duration and the second duration.

Optionally, the time information includes a second start moment, and the time determining module is configured to determine a start point of the target duration based on the second start moment, and determine an end point of the target duration based on the second start moment and a pre-stored duration.

Optionally, the reception controlling module is further configured to out of the target duration, perform at least one of the following operations: receiving a downlink beam signal; sending an uplink beam signal; or detecting a beam signal.

With respect to the apparatuses in the above embodiments, the specific manners for performing operations for individual modules therein have been described in detail in the embodiments regarding the methods, which will not be elaborated herein.

For the apparatus embodiments, since they basically correspond to the method embodiments, reference may be made to the partial description of the method embodiments for related parts. The apparatus embodiments described above are only illustrative, in which the modules described as separate components may or may not be physically separated, and the components displayed as modules may or may not be physical modules, that is, they may be located in one place or distributed over multiple network modules. Some or all of the modules may be selected according to actual needs to achieve the purpose of the solutions in some embodiments. Those skilled in the art can understand and implement it without creative effort.

Some embodiments of the disclosure also provide an electronic device, including:
a processor; and
a memory for storing instructions executable by the processor;
the processor is configured to perform the method for indicating a reception as described in any of the foregoing embodiments and/or the method for controlling a reception as described in any of the foregoing embodiments.

Some embodiments of the disclosure further provide a computer-readable storage medium, on which computer programs are stored, and when the programs are executed by a processor, the method for indicating a reception as described in any of the foregoing embodiments and/or the method for controlling a reception as described in any of the foregoing embodiments is performed.

As illustrated in FIG. 9. FIG. 9 is a schematic block diagram of a device 900 for indicating a reception according to some embodiments of the disclosure. The device 900 may be provided as a base station. The device 900 may include a processing component 922, a wireless transmit/receive component 924, an antenna component 926, and a signal processing portion specific to a wireless interface. The processing component 922 may further include one or more processors. One of the processors in the processing component 922 may be configured to perform the method for indicating a reception as described in any of the foregoing embodiments.

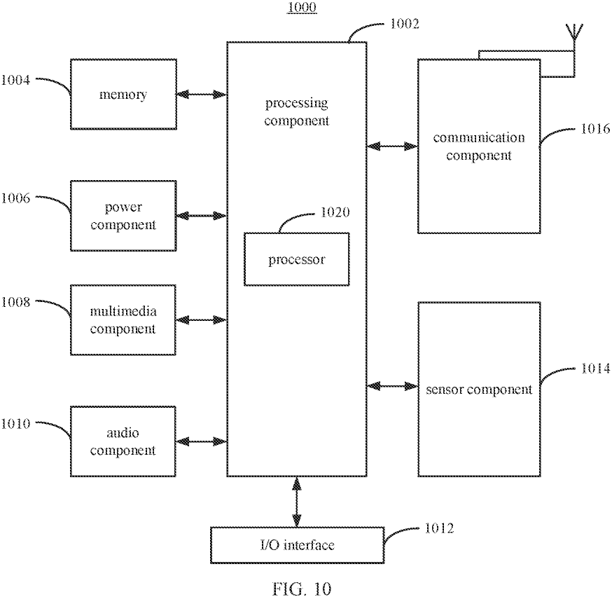

FIG. 10 is a schematic block diagram of a device 1000 for controlling a reception according to some embodiments of the disclosure. For example, the device 1000 may be a mobile phone, a computer, a digital broadcast terminal, a messaging device, a gaming console, a tablet, a medical device, exercise equipment, a personal digital assistant, and the like.

Referring to FIG. 10, the device 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the device 1000, such as the operations associated with display, telephone calls, data communications, camera operations, and recording operations. The processing component 1002 may include one or more processors 1020 to execute instructions to perform all or part of the steps in the above described methods for controlling a reception. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the device 1000. Examples of such data include instructions for any applications or methods operated on the device 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the device 1000. The power component 1006 may include a power management system, one or more power sources, and any other components associated with the generation, management, and distribution of power in the device 1000.

The multimedia component 1008 includes a screen providing an output interface between the device 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1008 includes a front camera and/or a rear camera. The front camera and the rear camera may receive an external multimedia datum while the device 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (“MIC”) configured to receive an external audio signal when the device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide status assessments of various aspects of the device 1000. For instance, the sensor component 1014 may detect an open/closed status of the device 1000, relative positioning of components, e.g., the display and the keypad, of the device 1000, a change in position of the device 1000 or a component of the device 1000, a presence or absence of user contact with the device 1000, an orientation or an acceleration/deceleration of the device 1000, and a change in temperature of the device 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the device 1000 and other devices. The device 1000 can access a wireless network based on a communication standard, such as WiFi, 2G, 3G, 4G LTE, 5G NR, or a combination thereof. In one embodiment, the communication component 1016 receives a broadcast signal or broadcast associated information from an external broadcast management system via a broadcast channel. In one embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In embodiments, the device 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for controlling a reception.

In embodiments, there is also provided a non-transitory computer-readable storage medium including instructions, such as included in the memory 1004, executable by the processor 820 in the device 1000, for performing the above-described methods for controlling a reception. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

It should be noted that, in the disclosure, relational terms such as first and second are used only to distinguish one entity or operation from another entity or operation, and do not necessarily require or imply any such actual relationship or sequence exists between these entities or operations. The terms “comprising”, “including” or any other variation thereof are intended to encompass non-exclusive inclusion such that a process, method, article, or device including a list of elements includes not only those elements, but also other elements not expressly listed, or also include elements inherent to such the process, method, article, or device. Without further limitation, an element qualified by the phrase “including a...” does not preclude the presence of additional identical elements in the process, method, article, or device that includes the element.

The methods and apparatuses or devices provided by embodiments of the disclosure have been described in detail above, and specific examples are used to illustrate the principles and implementations of the disclosure. At the same time, for those skilled in the art, according to the idea of the disclosure, there will be changes in the specific implementation and application scope. In summary, the contents of this specification should not be construed as limiting the disclosure.

1. A method for indicating a reception, performed by a base station, comprising:
determining an area corresponding to beams that a network device located in the air will turn off, and time information for turning off the beams; and
sending the time information to a terminal in the area.

2. The method of claim 1, wherein the time information comprises a first start moment and a first duration.

3. The method of claim 1, wherein the time information comprises an offset duration relative to a start point of a preset periodic time window and a second duration.

4. The method of claim 1, wherein the time information comprises a second start moment.

5. The method of claim 1, wherein the time information is carried in at least one of:
an extended paging channel signaling, a radio resource control (RRC) signaling, or physical layer downlink control information (DCI).

6. The method claim 1, wherein the base station comprises a base station located on the ground or the network device located in the air.

7. A method for controlling a reception, performed by a terminal, comprising:
receiving time information from a base station;
determining, based on the time information, a target duration during which a network device located in the air will turn off beams; and
during the target duration, stopping receiving a downlink beam signal, stopping sending an uplink beam signal, and stopping detecting a beam signal.

8. The method of claim 7, wherein the time information comprises a first start moment and a first duration, and determining, based on the time information, the target duration during which the network device located in the air will turn off the beams comprises:
determining a start point of the target duration based on the first start moment, and determining an end point of the target duration based on the first start moment and the first duration.

9. The method of claim 7, wherein the time information comprises an offset duration relative to a start point of a preset periodic time window and a second duration, and determining, based on the time information, the target duration during which the network device located in the air will turn off the beams comprises:
determining a start point of the target duration based on the start point of the preset periodic time window and the offset duration, and determining an end point of the target duration based on the start point of the target duration and the second duration.

10. The method of claim 7, wherein the time information comprises a second start moment, and determining, based on the time information, the target duration during which the network device located in the air will turn off the beams comprises:
determining a start point of the target duration based on the second start moment, and determining an end point of the target duration based on the second start moment and a pre-stored duration.

11. The method of claim 7, further comprising: out of the target duration, performing at least one of :
receiving a downlink beam signal;
sending an uplink beam signal; or
detecting a beam signal.

12. (canceled)

13. (canceled)

14. A terminal, comprising:
a processor; and
a memory for storing instructions executable by the processor;
wherein the processor is configured to:
receive time information from a base station;
determine, based on the time information, a target duration during which a network device located in the air will turn off beams; and
during the target duration, stop receiving a downlink beam signal, stop sending an uplink beam signal, and stop detecting a beam signal.

15. (canceled)

16. The terminal of claim 14, wherein the time information comprises a first start moment and a first duration, and the processor is further configured to:
determine a start point of the target duration based on the first start moment, and determine an end point of the target duration based on the first start moment and the first duration.

17. The terminal of claim 14, wherein the time information comprises an offset duration relative to a start point of a preset periodic time window and a second duration, and the processor is further configured to:
determine a start point of the target duration based on the start point of the preset periodic time window and the offset duration, and determine an end point of the target duration based on the start point of the target duration and the second duration.

18. The terminal of claim 14, wherein the time information comprises a second start moment, and the processor is further configured to:
determine a start point of the target duration based on the second start moment, and determine an end point of the target duration based on the second start moment and a pre-stored duration.

19. The terminal of claim 14, wherein the processor is further configured to, out of the target duration, perform at least one of:
receiving a downlink beam signal;
sending an uplink beam signal; or
detecting a beam signal.

20. A base station, comprising:
a processor; and
a memory for storing instructions executable by the processor;
wherein the processor is configured to perform the method of claim 1.
